(19) United States
(12) Patent Application Publication
(10) Pub. No.: US 2026/0192582 A1
(43) Pub. Date: Jul. 9, 2026

(54) METHOD AND SYSTEM FOR PRINTING CARDS

(71) Applicant: ATLANTIC ZEISER GMBH, Emmingen-Liptingen (DE)

(72) Inventors: Jens WALKERLING, Emmingen-Liptingen (DE); Thomas BINKELE, Emmingen-Liptingen (DE); Felix LIEBL, Emmingen-Liptingen (DE)

(73) Assignee: ATLANTIC ZEISER GMBH, Emmingen-Liptingen (DE)

(21) Appl. No.: 19/132,882

(22) PCT Filed: Nov. 28, 2023
(86) PCT No.: PCT/EP2023/083393

§ 371 Date: May 27, 2025

(30) Foreign Application Priority Data
Nov. 29, 2022 (IT) 102022000024579

(51) Int. Cl. B41J 13/12; B41J 3/407; B41J 11/00; B41J 13/10; B41M 3/00; B41M 5/00; B42D 15/02

(52) U.S. Cl. CPC B41J 13/12; B41J 3/407; B41J 11/0015; B41J 13/103; B41J 13/106; B41M 3/005; B41M 5/0011; B41M 5/0047; B41M 5/0064; B42D 15/02

(57) ABSTRACT

A card printing method includes: performing a surface treatment on a first surface of a first card in a card surface treatment station; printing on the first surface of the first card in a card printing station; flipping the first card; transporting a second card together with the first card to the card surface treatment station; performing the surface treatment on a second surface of the first card and on a first surface of the second card in the card surface treatment station; conveying together the first card and second card from the card surface treatment station to the card printing station; and printing the second surface of the first card and the first surface of the second card in the card printing station.

### CROSS-REFERENCE TO RELATED APPLICATIONS

This application is a § 371 National Phase of International Patent Application PCT/EP2023/083393, filed Nov. 28, 2023, which claims priority of Italian Patent Application No. 102022000024579, filed Nov. 29, 2022, the entire contents of all of which are incorporated by reference herein as if fully set forth.

### FIELD OF THE INVENTION

The present invention is directed to a card printing method and to a card printing system for printing on personalized cards, for instance ID cards, healthcare cards, phone cards, credit cards, bank cards, driver licenses, gift cards, access cards.

This invention is applicable preferably, although not exclusively, in the field of low-volume personalization system. Also, this invention is applicable equally preferably in the field of mid- to high-volume card personalization systems.

### BACKGROUND

ID cards, healthcare cards, phone cards, credit cards, bank cards, driver licenses, gift cards, access cards and several other types of personalized cards are generally made of plastics, paper, metal or hybrid material composition (for example metal and plastics), and generally have surfaces including plastic material.

On the respective surfaces, the personalized cards hold personalization data that can be printed or incorporated in the card in different ways, depending on functionalities and on security level requirements.

Personalization data include data belonging to the card holder such as name, surname, address, phone number, bank account number, insurance number, identification image. Other personalization data include personalized strings, images, messages, card number, card expiration date, linear or bi-dimensional codes, logos, names.

The known card personalization systems include a card printing system to print some of the personalization data on the card.

Said printing system can include one or more Drop-on-Demand (DoD) inkjet printer, which is able to print with selected colors (for example black, white, cyan, yellow, magenta) on the card surfaces, or part thereof.

DoD inkjet printer can print using thermal-inkjet technology or piezo-inkjet printing technology where pressure waves are used to eject selected amounts of ink from the nozzles of the printhead.

Ink formulation can vary depending on the printhead type and on the substrate characterizing cards to be printed. Ultraviolet and LED curable inks are especially suitable to print on plastic material. In particular, ultraviolet curable ink is preferred since it provides instant curing, light fastness, high print quality, adhesion, scratch resistance, color density, no volatile organic compounds. Water-based inks have also been developed in the recent years, which adhere to various types of crown-treated plastic substrates, with good mechanical and wet strength, high color rendering and high graphic quality.

The printer of the printing system can also support the so called “over the edge” printing or “edge-to-edge” printing or “full edge-to-edge” printing, where the full surface of the card is printed, without letting any visible non-printed edge or blank border. Over the edge printing allows to obtain a card having a high-quality result, which is of course more attractive for the end-user.

To guarantee high-quality standard printed cards, the known card printing system can include also one or more card surface treatment stations, to appropriately treat the card surfaces before printing. A surface treatment station can include air cleaning devices, corona treating devices, plasma treating devices, air plasma treating devices, gas plasma treating devices, as non-limiting examples.

Data that are not printed can be incorporated in the card for instance by encoding a chip or a magnetic stripe that are present in the card.

For this purpose, the card personalization system can include also processing stations to perform chip programming or magnetic stripe encoding.

Security features, holograms, embossed elements are non-limiting examples of cards additional features, for which it is needed that processing stations, comprising as non-limiting examples special coating devices, text embossers, laser markers, laser engravers, are included in the card personalization system.

Card personalization systems including card printing systems are used to treat and print up to thousands of cards per hour.

In this field important requirements to be fulfilled are guaranteeing a high-quality standard printing while maintaining a high throughput of the system in terms of cards printed per hour. Moreover, both surfaces of a plastic card need to be printed and treated.

An example of known system that processes high volume of cards is a printing system that is able to process cards in parallel, which requires that the printing stations and treatment stations are replicated on different paths. This increases the bulk, the costs and the footprint of the system.

In another example of known systems, cards are transported on a single path including a closed loop along which the stations of the card personalization system, for instance the printing station and the treatment station, are located.

In order to print the two sides of the card, these systems include at least one flipping station where the card is flipped before being returned back to the printing station and the treatment station, by using expensive and bulky belts or recirculation systems.

For the purpose of facilitating the comprehension of the present invention, the meaning of some terms and expressions as they are used in the present description and claims are set forth below.

A first operation on an object, for instance a card surface, or on a part thereof, is performed “directly after” a second operation on the same object or on the same part thereof when no further operations are performed between the start of the first operation and the end of the second operation. Preferably, the start of the first operation occurs within a limited period of time after the end of the second operation, this limited period of time being for instance less than 1 second, more preferably less than 600 milliseconds, even more preferably less than 200 milliseconds.

A first operation is performed “simultaneously” with a second operation when a null or substantially null period of time, for instance between 0 and 100 milliseconds, occurs between the first operation and the second operation.

With the term “card surface” it is intended one of the two flat surfaces having the greatest area on the opposite sides of a card and generally intended to be printed to include relevant information.

“Flipping a card” means rotating the card about an axis parallel to the surface of the card, in particular rotating the card by 180 degrees about said axis. When a card laying on a plane with its first surface is flipped, the same card lays on the plane with its second surface opposite to said first surface as a result of the flipping.

Two elements, such as two cards, are “conveyed together” from a first position to a second position, for example from a first station to a second station, when the movement of each element from the first to the second position depends on the movement of the other element. Preferably, the two elements are conveyed together when they are bound to each other during the movement from the first position to the second position, for instance when they are both moved by the same carrier.

In a card processing system where a card moves in a certain direction along a path, a first station is defined “upstream” a second station when said first station precedes said second station with reference to said direction, vice versa a second station is defined “downstream” a first station when said second station follows said first station with reference to said direction.

### SUMMARY

The Applicant observed that to guarantee high-quality printing on cards having surfaces including plastic material, it is necessary to appropriately treat the surfaces before being printed.

An important pre-printing treatment for cards having surfaces including plastic material is the plasma treatment that allows to clean the card surfaces by removing all volatile organic compounds before printing and to improve bonding characteristics for a better adhesion of the ink.

Known methods for printing on said cards are performed with card printing systems that include card surface treatment stations in addition to printing stations.

Known systems provide then some stations, positioned at an upstream position with respect to the printing station that include card manipulation devices and surface treatment devices.

The Applicant verified that in these systems card surface treatments are performed on both sides of a card before it is printed.

In particular, the first surface of a card is exposed to the surface treatment machine by moving the card below said machine; after treatment on the first surface, the card is flipped and returned back to the surface treatment machine, for example recirculated back at a position upstream with respect to the surface treatment machine, to perform the surface treatment on the second surface. After the treatment has been performed on both surfaces, the card is flipped a second time to be positioned in the first original position and it is sent to the printing station.

However, the Applicant observed that printing cards according to the previously described method could not guarantee to maintain a high-quality standard.

Actually, the Applicant perceived that the print quality could be affected by the steps performed before printing the cards and by the actions performed by devices manipulating said cards.

In particular, the Applicant noticed that the manipulation, namely the flipping and recirculating operations, performed after the treatment of a surface of a card can affect the following printing operation, since treated surfaces are particularly sensitive to external contamination and the improved bonding characteristics obtained by the surface treatment may be compromised. Moreover, the Applicant noticed that also the time between the card surface treatment and the printing may significantly increase the contamination possibilities.

The Applicant then perceived that it was needed to set up a method that minimizes the manipulation of a card and the time between the card surface treatment and the printing, while guaranteeing appropriate surface treatment to be performed on both surfaces of a card.

The Applicant has therefore found that a method in which a first card is treated by a surface treatment station on a first surface and printed by a printing station on this first surface, then flipped to be treated by the surface treatment station and printed by the printing station on a second surface while a second card is treated and printed on its first surface by the same surface treatment station and printing station, allows to print each surface of each card immediately after being treated, without the card being manipulated and, at the same time, allows to process two cards at the same time.

In a first aspect thereof, the invention relates to a method for printing on cards.

Preferably said cards have a respective first surface and a respective second surface.

Preferably said first surface and second surface comprise a plastic material.

Preferably said method includes the step of providing a card printing system.

Preferably said card printing system includes a card feeding station.

Preferably said card printing system includes a card surface treatment station.

Preferably said card printing system includes a card printing station.

Preferably said card printing system includes a card flipping station.

Preferably said card printing system includes a card exit station.

Preferably said method includes the step of feeding a first card at the card feeding station.

Preferably said method includes the step of performing a surface treatment on a first surface of the first card in the card surface treatment station.

Preferably said method includes the step of printing on the first surface of the first card in the card printing station.

Preferably said method includes the step of flipping the first card in the card flipping station.

Preferably said method includes the step of transporting a second card together with the first card, more preferably from the card feeding station to the card surface treatment station.

Preferably said method includes the step of performing the surface treatment on a second surface of the first card and on a first surface of the second card in the card surface treatment station.

Preferably said method includes the step of conveying together the first card and second card, more preferably from the card surface treatment station to the card printing station.

Preferably said method includes the step of printing the second surface of the first card and the first surface of the second card in the card printing station.

Preferably said method includes the step of removing the first card at the card exit station.

Preferably the method includes the above-mentioned steps in order, namely in the order such steps are mentioned above.

The Applicant verified that the above method not only guarantees a high-quality standard and over the edge print on both surfaces of a card, but it allows also to significantly increase the throughput of the system in terms of cards printed per hour. Indeed, it is possible to minimize the number of steps required and the number of devices present in the card printing system with said method, obtaining a card printing system with a reduced footprint.

In a second aspect thereof, the invention relates to a card printing system for printing on cards.

Preferably said cards have respective surfaces.

Preferably said surfaces comprise a plastic material.

Preferably said card printing system includes a card feeding station, more preferably intended to feed cards to the card printing system.

Preferably said card printing system includes a card exit station, more preferably intended to remove cards from the card printing system.

Preferably said card printing system includes a transport device. Preferably the transport device is movable along a first path. Preferably the transport device comprises a first seat and a second seat, more preferably intended to support two cards of said cards.

Preferably said card printing system includes a card surface treatment station.

Preferably said card surface treatment station is located downstream the card feeding station along said first path. More preferably said card surface treatment station is intended to perform a surface treatment on a respective surface of said cards.

Preferably said card printing system includes a card printing station.

Preferably said card printing station is located downstream the card surface treatment station along said first path. More preferably said card printing station is intended to print on said respective surface of said cards.

Preferably the transport device is movable along the first path from the card feeding station to the card surface treatment station, to the card printing station and to the card exit station.

The present invention in at least one of the above-mentioned aspects may have at least one of the preferred features set out below.

In a preferred embodiment said method includes after feeding a first card, the step of transporting said first card from said card feeding station to said card surface treatment station.

In a preferred embodiment said method includes after performing a surface treatment on a first surface of said first card, the step of conveying said first card from said card surface treatment station to said card printing station.

In a preferred embodiment, after said flipping, the first card is returned back to the card feeding station. In a preferred embodiment, said second card is fed at said card feeding station before the first card and the second card are transported to the card surface treatment station.

In this manner it is possible to increase the throughput of the system in terms of cards printed per hour.

In a preferred embodiment, said method includes the step of flipping the second card after printing said second surface of said first card and said first surface of said second card.

In this manner, the second card is ready to be treated and printed also on its second surface.

In a preferred embodiment, said second card flipping is performed simultaneously with removing said first card.

In a preferred embodiment, said card flipping station corresponds to said card exit station.

Advantageously this allows to have a system with a reduced footprint.

In a preferred embodiment, said transporting is carried out by a transport device. In a preferred embodiment, said conveying is carried out by a transport device. Preferably the transport device supports said first card and second card.

In a preferred embodiment, said method includes the step of feeding a second card to the card printing system. Preferably said second card is fed at the card feeding station.

In a preferred embodiment, said feeding a first card comprises providing said first card on a first seat of the transport device. In a preferred embodiment, said feeding a second card comprises providing said second card on said first seat of the transport device.

In a preferred embodiment, said method includes the step of flipping the second card in the card flipping station after printing on the first surface of the second card in the card printing station.

In a preferred embodiment, flipping said first card comprises moving said first card from said first seat to a second seat of said transport device. In a preferred embodiment, flipping said second card comprises moving said second card from said first seat to said second seat of the transport device.

In a preferred embodiment, removing the first card at the card exit station includes removing said first card from the second seat of the transport device.

In a preferred embodiment, said method includes the step of feeding a third card and a fourth card to the card printing system. Preferably said third card and fourth card are fed at the card feeding station. Preferably said third card is fed together with said first card. Preferably said fourth card is fed together with said second card.

In a preferred embodiment, said feeding a third card comprises providing said third card on a third seat of the transport device. In a preferred embodiment, said feeding a fourth card comprises providing said fourth card on a fourth seat of the transport device.

Preferably said method includes the step of performing the surface treatment on a first surface of the third card in the card surface treatment station, preferably after performing the surface treatment on the first surface of the first card.

Preferably said method includes the step of printing on the first surface of the third card in the card printing station, preferably after printing on the first surface of the first card.

Preferably said method includes the step of flipping together the first card and the third card in the card flipping station. In a preferred embodiment, flipping said third card comprises moving said third card from said third seat to the fourth seat of said transport device.

Preferably said method includes the step of transporting the third card and the fourth card together with the first card and the second card, more preferably from the card feeding station to the card surface treatment station.

Preferably said method includes the step of performing the surface treatment on a second surface of the third card and on a first surface of the fourth card in the card surface treatment station, preferably when performing the surface treatment on the second surface of the first card and on the first surface of the second card respectively.

Preferably said method includes the step of conveying together the first card, second card, third card and fourth card, more preferably from the card surface treatment station to the card printing station.

Preferably said method includes the step of printing the second surface of the third card and the first surface of the fourth card in the card printing station, preferably when printing the second surface of the first card and the first surface of the second card respectively.

Preferably said method includes the step of removing the third card at the card exit station, preferably when removing the first card.

In a preferred embodiment, removing the third card at the card exit station includes removing said third card from the fourth seat of the transport device.

In a preferred embodiment, said method includes moving said transport device from said card feeding station to said card exit station through said surface treatment station and said card printing station along a first path. In a preferred embodiment, said first path is a rectilinear path.

In a preferred embodiment, said method includes moving said transport device from said card exit station to said card feeding station along a second path. Preferably said second path is coincident with said first path. Alternatively and equally preferably, said second path is different from said first path.

In an equally preferred embodiment, said first path and said second path form a closed loop.

In a preferred embodiment, said method includes moving said transport device with continuous motion.

In a preferred embodiment, said method includes moving said transport device with a first mean speed from said card exit station to said card feeding station. In a preferred embodiment, said method includes moving said transport device with a second mean speed from said card feeding station to said card exit station. Preferably said first mean speed is higher than said second mean speed.

Advantageously this allows to have a system with a reduced footprint.

In a preferred embodiment, said method further includes after printing, the step of conveying at least one of said first card and second card to an ultraviolet ink curing station.

In a preferred embodiment, said method further includes the step of conveying said first card to an ultraviolet ink curing station after printing on said first surface of said first card.

In a preferred embodiment, said method further includes after conveying said first card to an ultraviolet ink curing station, the step of curing said first surface of said first card.

In a preferred embodiment, said method further includes the step of conveying together said first card and said second card to said ultraviolet ink curing station after printing said second surface of said first card and said first surface of said second card.

In a preferred embodiment, said method further includes after conveying together said first card and said second card to said ultraviolet ink curing station, the step of curing said second surface of said first card and said first surface of said second card.

In a preferred embodiment, said method further includes after printing, the step of conveying at least one of said first card and second card to a drying station, preferably an air-drying station, more preferably a hot air-drying station.

In a preferred embodiment, said method further includes the step of conveying said first card to a drying station, preferably an air-drying station, more preferably a hot air-drying station, after printing on said first surface of said first card.

In a preferred embodiment, said method further includes after conveying said first card to a drying station, the step of drying, preferably air drying, more preferably hot air drying, said first surface of said first card.

In a preferred embodiment, said method further includes the step of conveying together said first card and said second card to said drying station after printing said second surface of said first card and said first surface of said second card.

In a preferred embodiment, said method further includes after conveying together said first card and said second card to said drying station, the step of drying, preferably air drying, more preferably hot air drying, said second surface of said first card and said first surface of said second card.

In a preferred embodiment, said card surface treatment station is a plasma treatment station. In an equally preferred embodiment, said card surface treatment station is a corona treatment station.

In a preferred embodiment, said surface treatment is a plasma surface treatment. In an equally preferred embodiment, said surface treatment is a corona surface treatment.

In a preferred embodiment, said printing is performed directly after said surface treatment.

Preferably said printing is performed after said surface treatment in a time frame less than 1 second, more preferably less than 600 milliseconds, even more preferably less than 200 milliseconds, for instance in 150 milliseconds.

Advantageously this allows to have a high-quality printing on the full surface of a card.

In a preferred embodiment said method includes after removing the first card, the step of transporting said second card to said card feeding station.

In a preferred embodiment said method includes after removing the first card, the step of feeding a further card.

In a preferred embodiment, said card printing station includes at least one drop on demand inkjet printer.

In a preferred embodiment, said card printing station includes at least one ultraviolet inkjet printer.

In a preferred embodiment, said transport device comprises at least one of a conveyor, a belt, a rail assembly and a shuttle.

Preferably, said transport device comprises a shuttle. Preferably said shuttle is movable along said first path from said card feeding station to said card surface treatment station, to said card printing station and to said card exit station. Thanks to the employment of the same shuttle, no handlings of the cards moving from the card surface treatment station to the card printing station are needed. Advantageously, no handling device is needed between the card surface treatment station and the card printing station and any damage of the cards surfaces after being treated and before printing is avoided.

In a preferred embodiment, the transport device comprises a first seat, a second seat, a third seat and a fourth seat, more preferably intended to support four cards of said cards.

In a preferred embodiment, said card printing system includes a card alignment station.

Preferably the card alignment station is positioned downstream said card feeding station. Preferably the card alignment station is positioned upstream said surface treatment station.

Preferably said card alignment station is intended to align said at least one card, more preferably when positioned on said transport device.

Preferably said card printing system includes a card flipping station. Preferably said card flipping station is intended to flip the cards.

Preferably said card flipping station is located either downstream said printing station or upstream said card surface treatment station along said first path.

Preferably said card printing system includes a card printing assembly. Preferably said card printing assembly comprises said card surface treatment station and card printing station. More preferably said card printing assembly consists of said card surface treatment station and card printing station.

### BRIEF DESCRIPTION OF THE DRAWINGS

The features and advantages of the invention will be clear from the detailed description of a preferred embodiment thereof, which is illustrated by way of nonlimiting example with reference to the appended drawing, in which:

FIG. 1 is a schematic representation of a card printing system operating according to a method for printing on cards according to the present invention.

FIGS. 2A and 2B are respective views of a first surface and second surface, opposite to the first surface, of a card to be printed by a card printing system according to the present invention.

FIG. 3 is a schematic view of a first card and a second card located on a transport device of the card printing system according to the present invention.

### DETAILED DESCRIPTION OF THE PREFERRED EMBODIMENTS

With reference to the appended drawing, the card printing system realized to operate according to the method of the present invention, is designated as a whole with 100.

In the preferred embodiment described here below, the card printing system 100 is part of a card personalization system 170 which may include also one or more card processing stations 138 positioned upstream or downstream the card printing system 100.

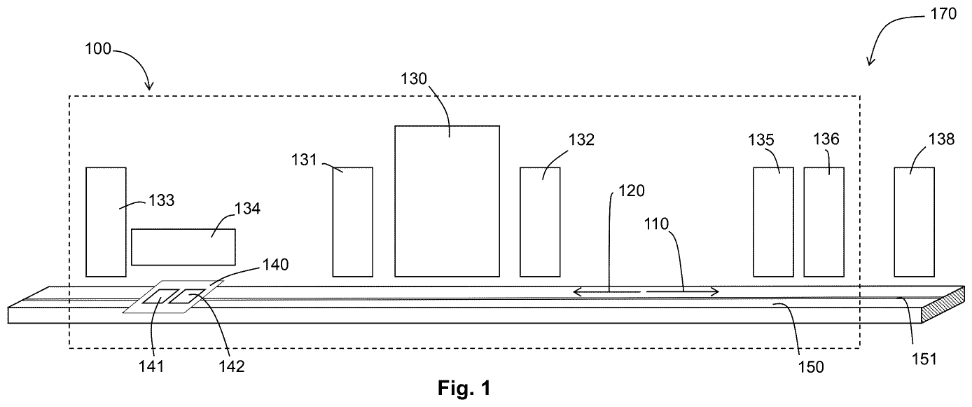

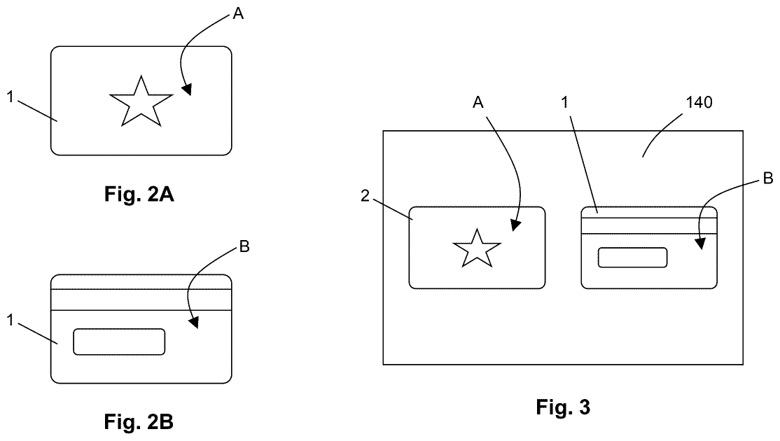

With reference to FIG. 1, a card processing station 138 is positioned downstream the card printing system 100 and is one or more of a chip programming station, a laser marking station, a magnetic band encoding station, a print verification station, a card sorting station, an embossing station, a lamination station or a label application station.

The card printing system 100 includes a card feeding station 133, a card alignment station 134, a card surface treatment station 131, a card printing station 130, a card ultraviolet ink curing station 132, a card flipping station 135 and a card exit station 136.

The card feeding station 133 includes manipulation or pushing devices intended to feed a card, for instance taken from a stack of cards (not illustrated), to the next stations. The cards have a respective first surface A and a respective second surface B to be both printed, the second surface B being opposite to the first surface A.

The card alignment station 134 includes a card alignment mechanism to align the card along a certain direction.

The card surface treatment station 131 includes devices to perform a treatment on a surface of the card: in a preferred embodiment said card surface treatment station 131 is a plasma treatment station and said surface treatment is a plasma surface treatment.

The card printing station 130 includes one or more printers including one or more printheads. Preferably, printers are Drop-on-Demand inkjet printers using ultraviolet curable ink. In the illustrated embodiment, the card printing station 130 is arranged immediately after, for instance at a distance less than 7 cm, the surface treatment station 131, in such a manner that printing is performed directly after the surface treatment to minimize the time between the two operations.

The UV curing station 132 cures the ink after the card is printed.

The card flipping station 135 includes further manipulation or pushing devices to flip the card, in particular rotating the card by 180 degrees about an axis parallel to the surface of the card.

The card exit station 136 includes still further manipulation or pushing devices intended to output the printed card from the card printing system 100.

In a preferred embodiment the card flipping station 135 and the card exit station 136 correspond.

The card printing system 100 also includes a transport device 150 arranged to move one or more cards, for instance two cards, between the above stations.

The transport device 150 comprises a rail assembly 151 and a shuttle 140 moved on the rail assembly 151 by a driving device such as a motor.

The rail assembly 151 is substantially rectilinear and the shuttle 140 is moved along the rail assembly 151 along a first path 110, defined from the feeding station to the exit station, or along a second path 120, defined from the exit station 136 to the feeding station 133, with a direction opposite to the first path 110.

The shuttle 140 of the transport device 150 includes card seats 141, 142, each provided to support a respective card. In the illustrated embodiment, the shuttle 140 include a first seat 141 and a second seat 142 to support two cards.

In order to improve the cohesion of the cards and avoid undesired slippage of the cards, the transport device 150 can include a vacuum system, for instance a plate to support the cards, this plate having one or more holes connected to a suction pump. The suction pump draws air from the one or more holes and, when the card is located on the plate, holds the card firmly on the transport device 150.

When the shuttle 140 is moved along the rail assembly 151, it conveys the cards from the card feeding station 133 to the card alignment station 134, to the card surface treatment station 131, to the card printing station 130, to the card ultraviolet ink curing station 132, to the card flipping station 135, up to the card exit station 136 along the first path 110, and back from the exit station 136 to the feeding station 133 along the second path 120.

When the card personalization system 170 operates, the card feeding station 133 takes a first card 1 from the stack of cards and place it in the first seat 141 of the shuttle 140. For instance, the second surface B of the first card 1 contacts the first seat 141 and the first surface A of the first card 1 doesn't contact the shuttle 140, consequently the first surface A of the first card 1 is intended to face the stations following the card feeding station 133 along the first path 110.

The shuttle 140 transports the first card 1 along the first path 110 from the card feeding station 133 to the card alignment station 134, where the first card 1 is aligned along the direction defined by the first path 110, and then to the card surface treatment station 131, to the card printing station 130 and to the ultraviolet ink curing station 132, where the first surface A of the first card 1 is treated, printed and cured respectively.

The shuttle 140 then transports the first card 1 to the card flipping station 135, where the first card is removed from the first seat 141, flipped and positioned in the second seat 142 of the shuttle 140. Now the first surface A of the first card 1 contacts the second seat 142 and the second surface B of the first card 1 doesn't contact the shuttle 140.

After the first card 1 is positioned in the second seat 142, the shuttle 140 moves along the second path 120 back to the feeding station 133 at a speed higher than the speed along the first path 110, and the card feeding station 133 takes a second card 2 from the stack of cards and place it in the first seat 141 of the shuttle 140. For instance, the second surface B of the second card 2 contacts the first seat 141 and the first surface A of the second card 2 doesn't contact the shuttle 140. Consequently, the first surface A of the second card 2 and the second surface B of the first card 1 are intended to face the stations following the card feeding station 133 along the first path 110 (see FIG. 3).

The shuttle 140 is then moved again along the first path 110 so that the first card 1 and the second card 2 are transported together to the card alignment station 134, where the first card 1 and the second card 2 are aligned along the direction defined by the first path 110, and then to the card surface treatment station 131, the card printing station 130 and the ultraviolet ink curing station 132, where the second surface B of the first card 1 and the first surface A of the second card 2 are treated, printed and cured respectively.

The shuttle 140 transports together the first card 1 and the second card 2 to the card flipping station 135, where the first card is removed from the second seat 142, possibly flipped, and output at the card exit station 136, and the second card 2 is removed from the first seat 141, flipped and positioned in the second seat 142 of the shuttle 140. Now the first surface A of the second card 2 contacts the second seat 142 and the second surface B of the second card 2 doesn't contact the shuttle 140.

After the second card 2 is positioned in the second seat 142, the shuttle 140 moves along the second path 120 back to the feeding station 133, and the card feeding station 133 takes a further card from the stack of cards and place it in the first seat 141 of the shuttle 140.

The steps described above can now be repeated assuming that the second card 2 is treated as a first card and the further card is treated as a second card.

Naturally, a person skilled in the art could apply additional modifications and variants to the invention described above for the purpose of complying with specific and contingent application requirements, variants and modifications in any case being included within the scope of protection as defined by the appended claims.

1. A method for printing on cards having a respective first surface and a respective second surface, wherein said first surface and second surface comprise a plastic material, said method comprising in order:
providing a card printing system including a card feeding station, a card surface treatment station, a card printing station, a card flipping station and a card exit station, wherein said card surface treatment station is a plasma treatment station;
feeding a first card at said card feeding station;
performing a plasma surface treatment on a first surface of said first card in said card surface treatment station;
printing on said first surface of said first card in said card printing station;
flipping said first card in said card flipping station;
transporting a second card together with said first card from said card feeding station to said card surface treatment station;
performing said plasma surface treatment on a second surface of said first card and on a first surface of said second card in said card surface treatment station;
conveying together said first card and second card from said card surface treatment station to said card printing station;
printing said second surface of said first card and said first surface of said second card in said card printing station;
removing said first card at said card exit station.

2. The method according to claim 1, wherein after said flipping, said first card is returned back to said card feeding station, and said second card is fed at said card feeding station before said first card and second card are transported to said card surface treatment station.

3. The method according to claim 1, wherein after printing said second surface of said first card and said first surface of said second card, said second card is flipped.

4. The method according to claim 3, wherein said second card flipping is performed simultaneously with removing said first card.

5. The method according to claim 1, wherein said transporting and said conveying are carried out by a transport device supporting said first card and second card.

6. The method according to claim 5, wherein said feeding a first card comprises providing said first card on a first seat of said transport device.

7. The method according to claim 6, wherein said flipping said first card comprises moving said first card from said first seat to a second seat of said transport device.

8. The method according to claim 5, wherein said transport device is moved from said card feeding station to said card exit station through said card surface treatment station and said card printing station along a first path.

9. The method according to claim 8, wherein said transport device is moved from said card exit station to said card feeding station along a second path, said second path being coincident with said first path.

10. The method according to claim 1, wherein said printing is performed directly after said plasma surface treatment.

11. A card printing system for printing on cards having respective surfaces comprising a plastic material, the card printing system including:
a card feeding station configured to feed cards to said card printing system;
a card exit station configured to remove cards from said card printing system;
a transport device movable along a first path and comprising a first seat and a second seat configured to support two cards of said cards;
a card surface treatment station located downstream said card feeding station along said first path and configured to perform a surface treatment on a respective surface of said cards, wherein said card surface treatment station is a plasma treatment station;
a card printing station located downstream said card surface treatment station along said first path and configured to print on said respective surface of said cards;
wherein said transport device comprises a shuttle, and said shuttle is movable along said first path from said card feeding station to said card surface treatment station, to said card printing station and to said card exit station.

12. The card printing system according to claim 11, wherein said first path is a rectilinear path.

13. The card printing system according to claim 11, wherein said card printing station comprises at least one drop on demand inkjet printer.

14. The card printing system according to any claim 11, wherein said card printing station comprises at least one ultraviolet inkjet printer.

15. The card printing system according to claim 11, further comprising a card flipping station configured to flip said cards, said card flipping station being located either downstream said printing station or upstream said card surface treatment station along said first path.
